(19) United States
(12) Patent Application Publication
(10) Pub. No.: US 2006/0108080 A1
(43) Pub. Date: May 25, 2006

(54) Continuous retractable shade for non-linear windows

(75) Inventors: Jeffrey M. Garrigues, Firestone, CO (US); Scott W. Thompson, Longmont, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Carefree/Scott Fetzer Company, Broomfield, CO (US)

(21) Appl. No.: 10/992,918

(22) Filed: Nov. 19, 2004

(51) Int. Cl. B60J 1/20

(52) U.S. Cl. 160/370.23

(57) ABSTRACT

A retractable shade finding particular use in covering non-linearly aligned architectural openings or curved openings, includes one continuous curtain following a predetermined path along the openings. A segmented drive system forms linear segments of a drive system which in combination are adjustable to accommodate various curvatures of openings or angles between adjacent architectural openings. Movement of the shade between retracted and extended positions is automatically stopped and a fail-safe system is provided to prevent inadvertent extension of the shade such as when the shade is used to cover the windshield of a recreational vehicle or the like.

### BACKGROUND OF THE INVENTION

1. Field of the Invention

The present invention relates to retractable shades for non-linear windows and more specifically to a wrap-around retractable shade which amongst other uses finds a specific use in recreational vehicles, motor homes, and the like, for selectively covering the windshield and adjacent windows which are not in linear alignment.

2. Description of the Relevant Art

Retractable shades, such as venetian blinds, pleated shades, cellular shades, and the like, are a common covering for architectural openings such as doors, windows, archways, and the like, and are also employed in mobile structures such as recreational vehicles, motor homes, travel trailers, and the like.

Such retractable coverings are typically planar, i.e. linearly constructed so as to accommodate a flat opening while being movable between an extended position across the opening and a retracted position adjacent one edge of the opening.

Not all openings in building structures, recreational vehicles, mobile homes, and the like, however, are flat and linear, but rather some have a curvature or in the case of building structures, there are bay windows wherein a plurality of side-by-side windows are not linearly aligned but rather form an angle relative to each other. Similarly, in recreational vehicles and the like, the windshield of the vehicle may have a curvature and be in angular side-by-side relationship with windows on the side of the vehicle where it would be desirable to have a retractable covering that would cover not only the windshield but also the windows adjacent thereto.

In the case of bay windows, vertically retractable coverings are typically provided for each window so there are a plurality of retractable shades associated with the bay window. Some bay windows are provided with a continuous horizontally retractable shade such as curtains, draperies, vertical blinds or the like, and utilize one continuous curved rod but such coverings are not acceptable if a vertically retractable shade is desired.

The present invention has been designed to provide a continuous vertically retractable shade that can be used on curved windows or adjacent non-linearly aligned windows.

### BRIEF SUMMARY OF THE INVENTION

The present invention is a vertically retractable shade, which incorporates a collapsible curtain that could take on numerous forms such as a pleated shade, cellular shade, slatted shade, flexible sheet of material or the like. The invention is designed to provide a retractable covering finding a unique use with curved openings or non-linearly aligned adjacent openings in a building structure, recreational vehicle, mobile home, or the like.

The retractable shade includes the collapsible curtain, which is adapted to be moved between an extended position across the opening and a retracted position adjacent one edge of the opening and a control system for moving the curtain between the extended and retracted positions.

The control system includes a plurality of adjacent elongated lift shafts. The lift shafts have adjacent ends and the lift shafts may or may not be in linear alignment. The lift shafts are rotatable about their longitudinal axes and are interconnected at their adjacent ends with transmitters that transmit the rotational movement of one lift shaft to the next adjacent shaft so that all of the shafts rotate in unison. A drive system in the form of a motor or interconnected motors is operatively connected to the lift shafts for selectively rotating them about their longitudinal axes. At least some of the lift shafts have a cord-winding spool mounted thereon for unitary rotation therewith, the spools being adapted to have a lift cord wrapped or unwrapped thereabout. The lift cords extend through the curtain to a bottom rail so that as the lift cord is wrapped around an associated spool, the bottom rail is moved toward the lift shafts thereby moving the retractable shade between its extended and retracted position. Movement of the lift shafts in an opposite direction allows the lift cords to unwrap from their associated spools and the weight of the bottom rail causes it to drop with the connected curtain by gravity thereby moving the retractable shade from its retracted to its extended position.

Each elongated lift shaft extends along an edge of the opening in the building structure, vehicle, or the like, and may extend along the entire length of the opening or along a segment of the opening if the opening is curved. The angle between adjacent lift shafts can be varied within given parameters of the transmitters to accommodate various curvatures of openings or angular relationships between adjacent openings which in combination define a segment of the building structure, vehicle, or the like, which is being covered by the retractable shade.

The curtain can be continuous and is utilized to cover the entire opening or adjacent openings in the building structure, vehicle or the like. Notched openings are provided in the curtain to allow bends in the curtain to be accommodated without the curtain buckling. Where the notches are formed in the curtain, inserts may be provided to cover the notched openings to prevent the passage of vision or light through the notched openings.

Other aspects, features, and details of the invention can be more completely understood by reference to the following detailed description of a preferred embodiment, taken in conjunction with the drawings and from the appended claims.

### BRIEF DESCRIPTION OF THE DRAWINGS

FIG. 1 is a fragmentary isometric looking at the front of a recreational vehicle having the retractable shade of the present invention incorporated therein in a retracted position.

FIG. 2 is a fragmentary isometric similar to FIG. 1 with the retractable shade shown in an extended position.

FIG. 3 is an enlarged fragmentary section taken along line 3-3 of FIG. 2.

FIG. 4 is an enlarged fragmentary section taken along line 4-4 of FIG. 2.

FIG. 5 is an isometric looking downwardly on the retractable shade of the present invention in an extended position and removed from the vehicle of FIG. 1.

FIG. 6 is an isometric similar to FIG. 5 showing the shade in a retracted position.

FIG. 7 is an isometric similar to FIG. 5 looking at the rear side of the retractable shade.

FIG. 8 is a front elevation of the retractable shade in a fully extended position.

FIG. 9 is an enlarged section taken along line 9-9 of FIG. 8.

FIG. 10 is a section taken along line 10-10 of FIG. 8.

FIG. 11 is a section similar to FIG. 10 showing the shade assuming an alternative configuration.

FIG. 12 is a section similar to FIGS. 10 and 11 with the shade assuming a still different configuration.

FIG. 13 is a fragmentary horizontal section looking upwardly at the intersection of a lift shaft with a transmitter.

FIG. 14 is a vertical section with the shade in an extended position and looking at a location where the headrail for the shade is anchored to a horizontal support surface in the recreational vehicle of FIG. 1.

FIG. 14A is a plan view looking at the front of a bevel gear used on a lift shaft.

FIG. 14B is a side elevation of the gear of FIG. 14A.

FIG. 14C is a bottom plan view of the gear of FIG. 14A.

FIG. 15 is a fragmentary plan view looking at the intersection of three component parts of the bottom rail for the retractable shade of the invention.

FIG. 16 is an exploded isometric showing the component parts of the bottom rail illustrated in FIG. 15.

FIG. 17 is an enlarged fragmentary section taken along line 17-17 of FIG. 8.

FIG. 18 is a fragmentary section similar to FIG. 17 with the curtain shown in a different orientation.

FIG. 19 is a section similar to FIGS. 17 and 18 with the curtain shown in a still different orientation.

FIG. 20 is an enlarged fragmentary section taken along line 20-20 of FIG. 8.

FIG. 21 is a fragmentary section similar to FIG. 20 with the curtain in a different orientation.

FIG. 22 is a fragmentary horizontal section taken through three segments of the curtain of the retractable shade of the invention showing an insert incorporated therein for covering notches in the curtain.

FIG. 23 is an enlarged fragmentary section taken along line 23-23 of FIG. 22.

FIG. 24 is a fragmentary isometric similar to FIG. 22 showing an insert prior to insertion into the curtain.

FIG. 25 is an exploded isometric showing a central portion of the headrail for the retractable shade of the invention and components of the motor drive system for moving the shade between extended and retracted positions.

FIG. 26 is an exploded isometric of a portion of the headrail having a lift shaft and spool therein.

FIG. 27 is an exploded fragmentary isometric of an endmost component of the headrail having the switch system for energizing and de-energizing the motor drive for the retractable shade of the invention.

FIG. 28 is a fragmentary isometric showing a stop used to limit movement of the retractable shade.

FIG. 29 is an exploded fragmentary isometric looking upwardly at the transmitter between adjacent lift shafts of the retractable shade.

FIG. 30 is an exploded isometric of a transmitter used in the retractable shade.

FIG. 31 is an enlarged section taken along line 31-31 of FIG. 13.

FIG. 32 is an enlarged section taken along line 32-32 of FIG. 13.

### DETAILED DESCRIPTION OF THE INVENTION

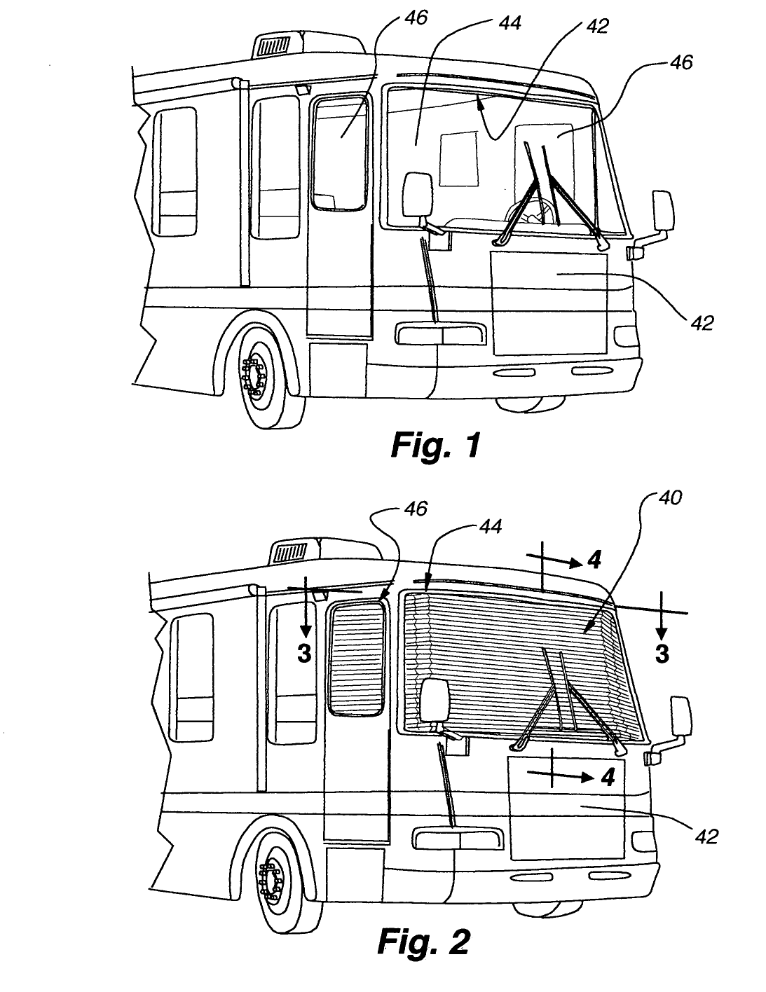

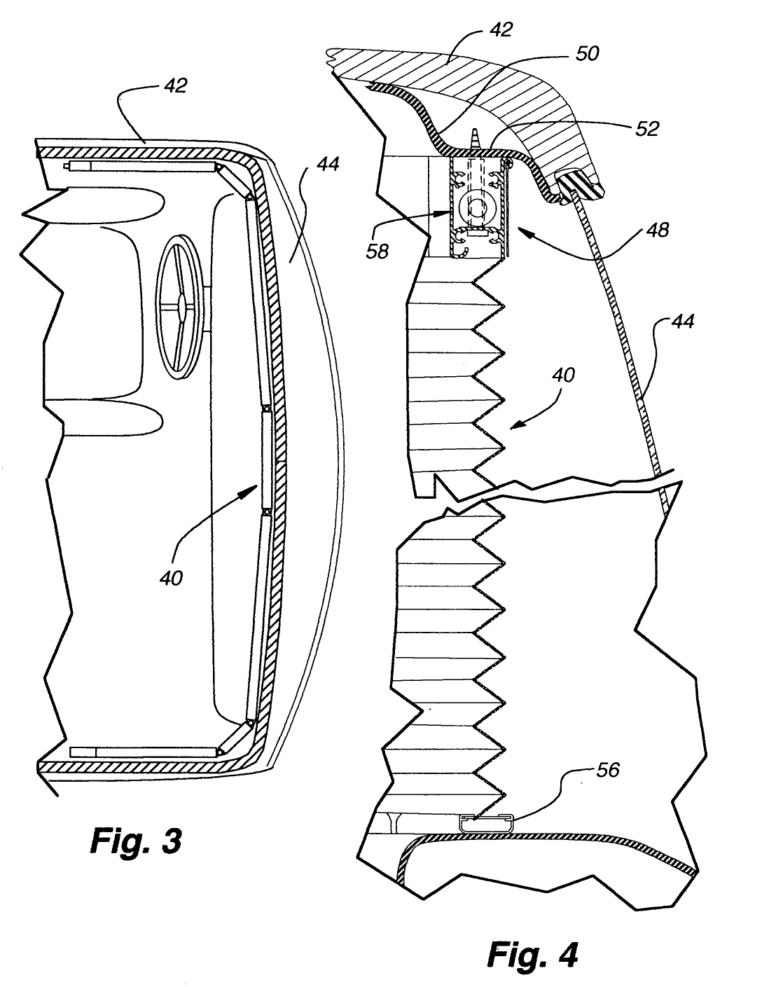

The retractable shade 40 of the present invention is primarily designed for use in architectural openings such as windows, doors, and the like, which are not linear or linearly aligned so that the shade must assume a non-linear configuration. For purpose of the present disclosure, non-linear means not in a straight line. Examples of environments for use of a retractable shade of the type disclosed in the present application would be arcuate windows and windows which are adjacent to each other but in non-linear alignment even though the concepts of the invention would be equally applicable for flat windows or linearly aligned windows. For purposes of the present disclosure, however, the retractable shade 40 of the present invention will be described for use in the front of a recreational vehicle 42 wherein the windshield 44 of the vehicle is arcuate and is non-linearly aligned at opposite side edges with side windows 46 of the vehicle. The shade is adapted to wrap continuously across the front of the vehicle so as to selectively cover not only the arcuate windshield but also the side windows adjacent thereto. The vehicle 42 incorporating the retractable shade of the present invention is shown in FIGS. 1-3 with FIG. 1 showing the shade in a fully retracted position, FIG. 2 showing the shade in a fully extended position, and FIG. 3 being a horizontal section illustrating the wraparound nature of the shade.

The shade 40 includes a headrail 48, which is divided into a plurality of longitudinally adjacent component parts 48a, 48b, 48c and 48d, each of which is securable to a headliner 50 in the vehicle as probably best seen in FIG. 4. The headliner 50 has a horizontal wall 52 following the wraparound contour of the vehicle body so the component parts of the headrail 48 can be secured to the headliner at a common elevation and in adjacent relationship with other component parts. The headrail 48 serves as a support for a retractable curtain 54 which could assume many different configurations such as a pleated shade material, cellular shade material, a sheet material, or the like. For purposes of the present disclosure, the curtain 54 is shown as a pleated material that is continuous along the curvature at the front of the vehicle to be covered by the retractable shade. The curtain has a weighted bottom rail 56 that will be described in more detail hereafter extending along its lower edge and also following the contour of the front of the vehicle.

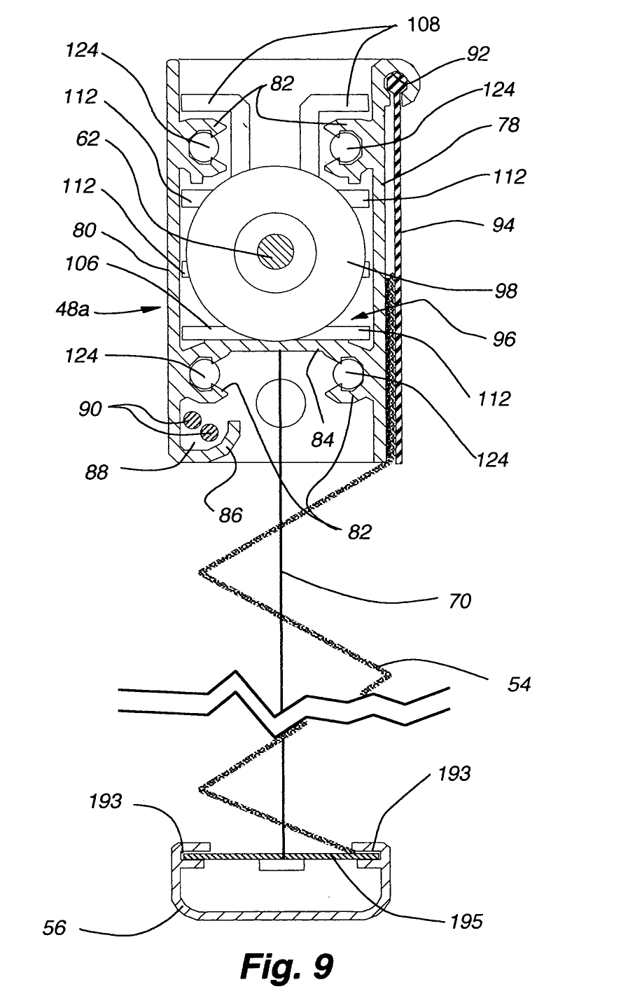

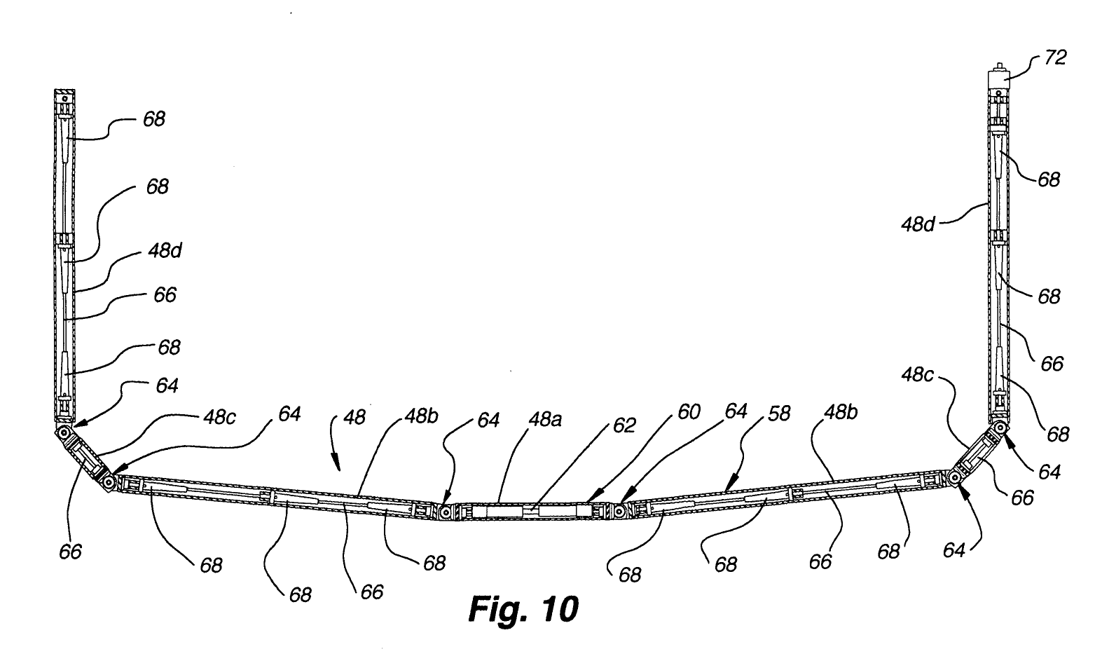

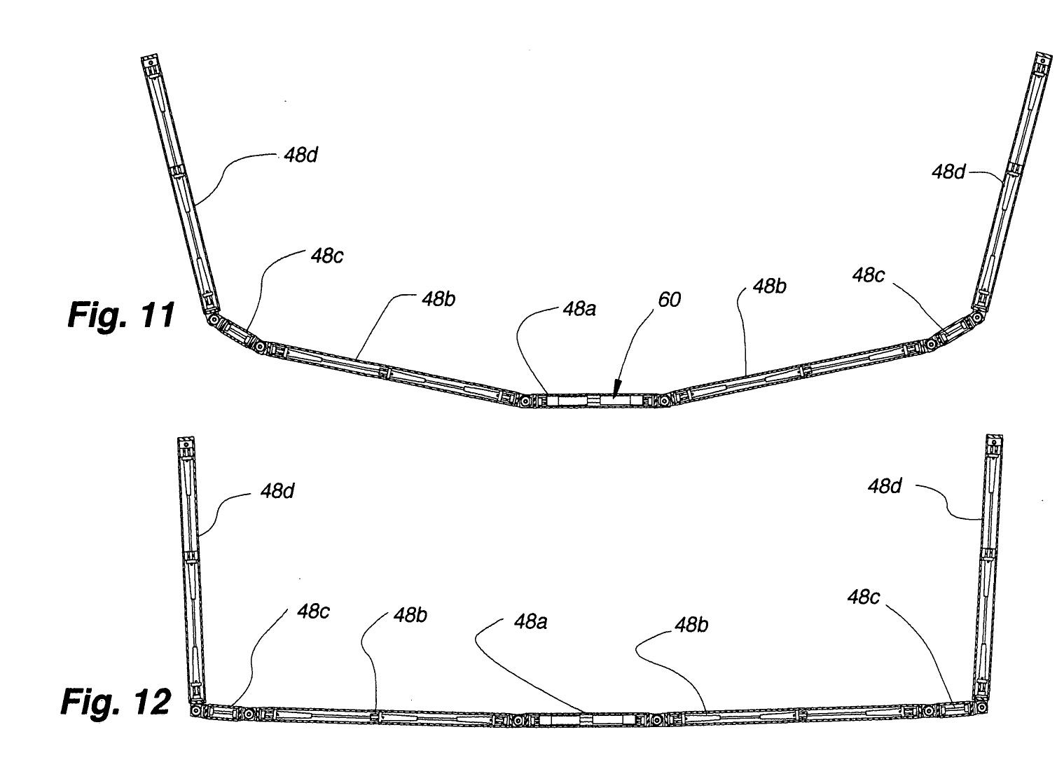

The curtain 54 is moved between the retracted position of FIG. 1 and the extended position of FIGS. 2 and 4 with a control system 58 that is primarily confined within the headrail. The control system, as best appreciated by reference to FIG. 10, includes a motor drive unit 60, which in the disclosed embodiment is centered at the front of the vehicle windshield 44 with drive shafts 62 extending in opposite directions and laterally towards the sides of the vehicle. The drive shafts operatively engage geared transmitters 64 which are in turn operatively connected with lift shafts 66 that extend toward the opposite side edges or ends of the retractable shade. The lift shafts are associated with spools 68 rotatably mounted within the headrail components even though each lift shaft does not need to be associated with a spool. The headrail components 48a, 48b, 48c and 48d are interconnected by the transmitters 64 so that lift shafts in each headrail component will rotate at a common rotational speed. Each spool is associated with a lift cord 70 (FIG. 9) that extends downwardly through the pleated curtain 54 and is anchored at its lower end to the bottom rail 56 of the retractable shade. Rotational movement of the spool with the motor-driven lift shafts 66 causes the lift cords to be wrapped about or unwrapped from an associated spool in moving the curtain between the extended and retracted positions, respectively.

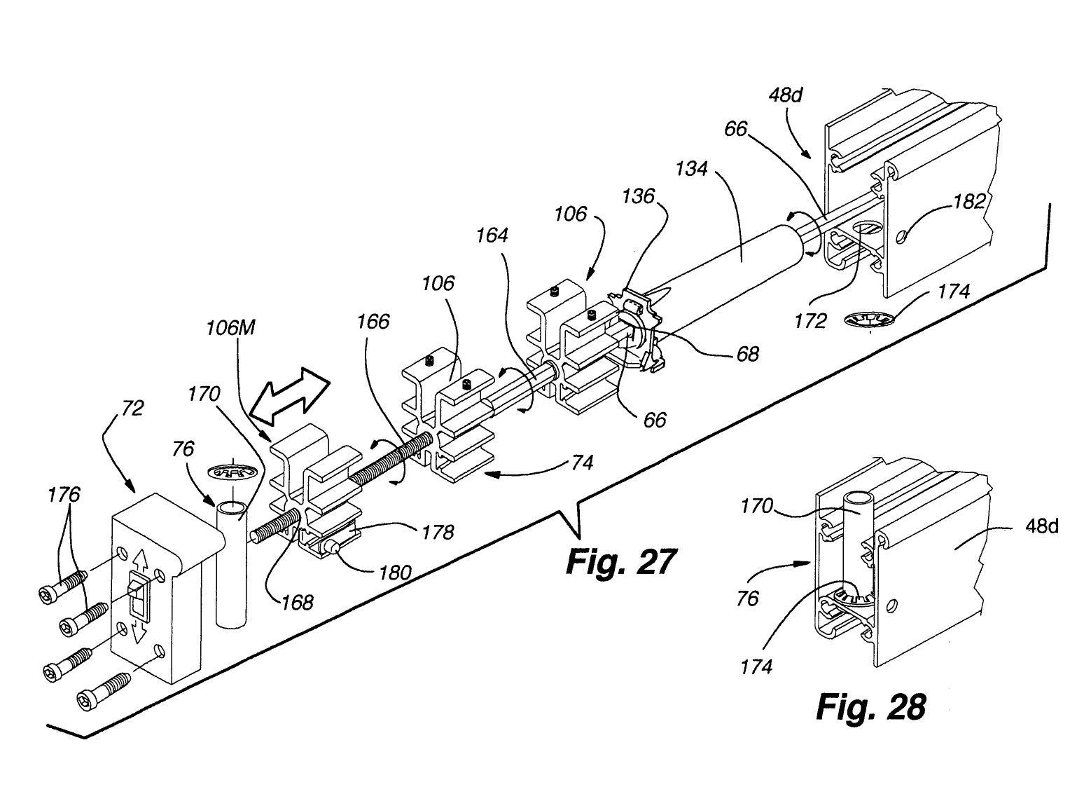

A manually operable switch 72 (FIG. 10) energizes the motor unit for raising or lowering the curtain and limit stops 74 and 76 (FIG. 27), adjacent to the switch, which will be described in more detail later, are provided for limiting the extending or retracting movement of the curtain automatically when it reaches either the fully retracted or fully extended position.

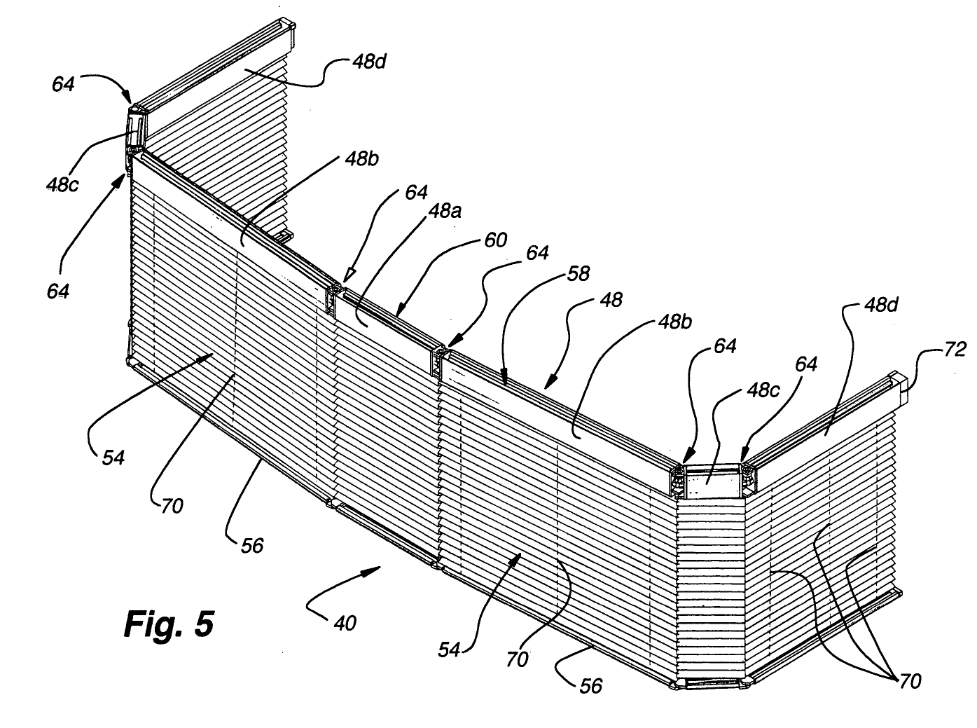

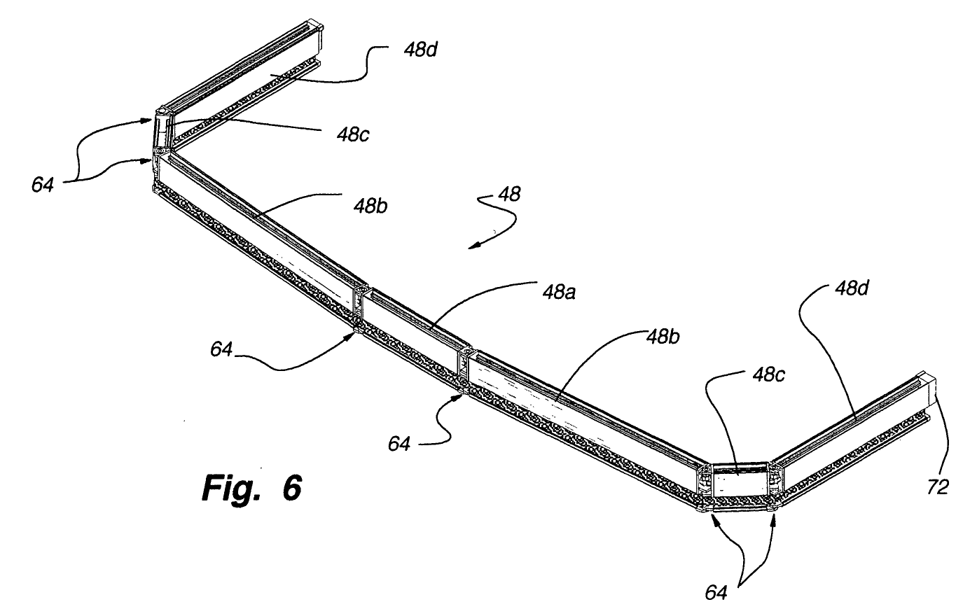

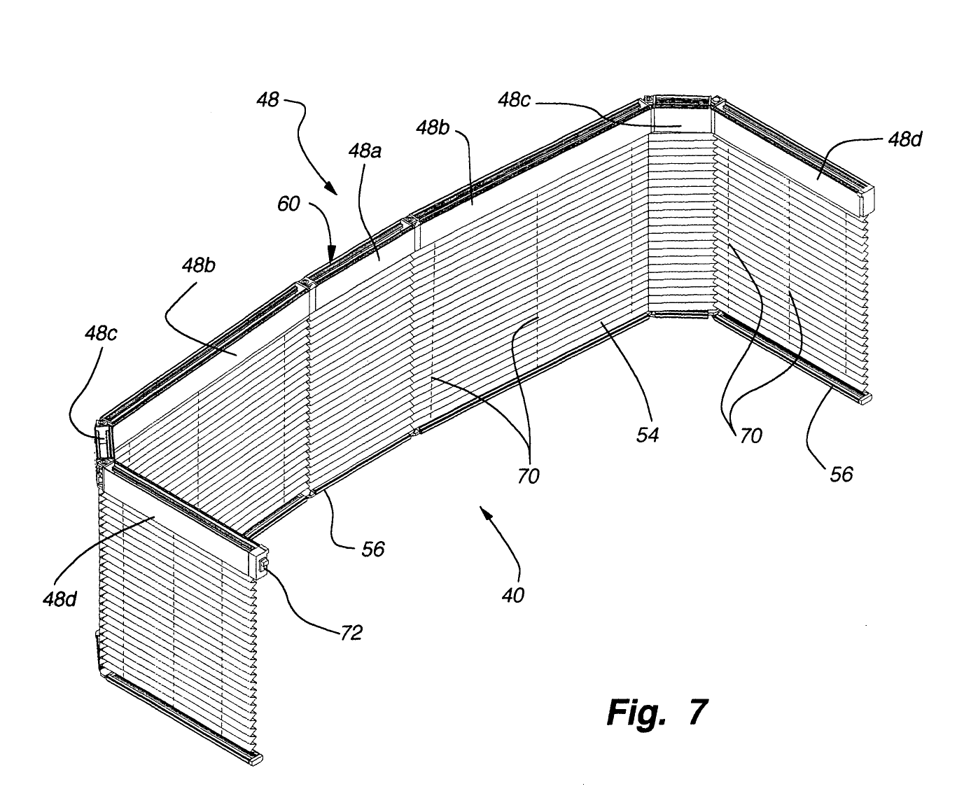

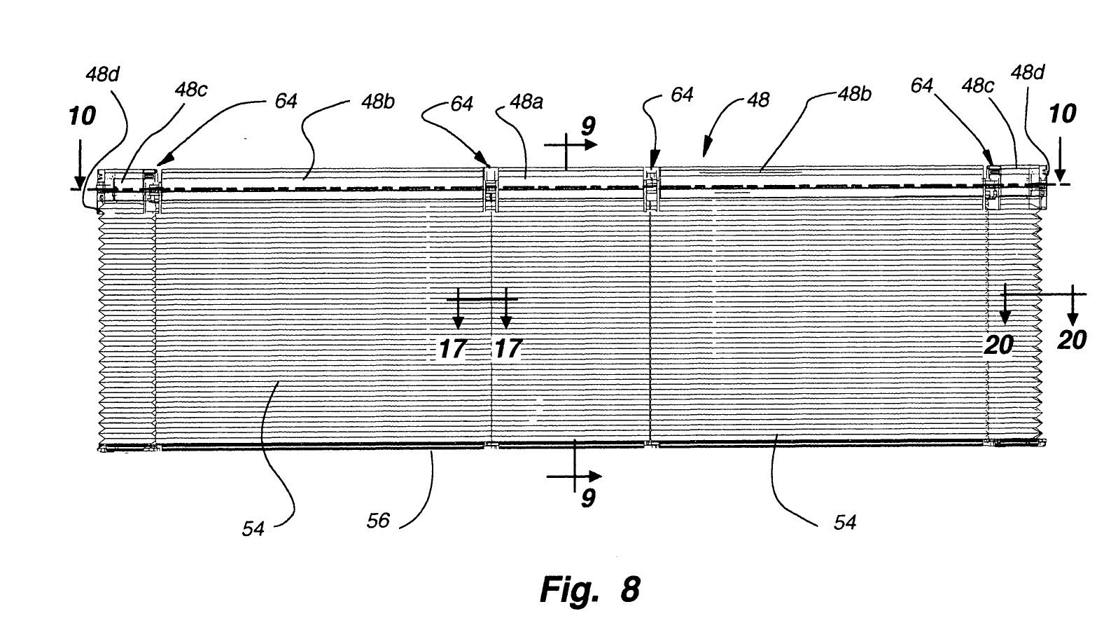

With reference to FIGS. 5-8, the retractable shade 40 is shown independently of the vehicle 42 and it is there seen that the headrail 48 in the disclosed embodiment has seven components with the center component 48a housing the drive motor unit 60 as will be described hereafter and with three components 48b, 48c and 48d extending in opposite directions from the center component. The components 48b adjacent to each side of the center component 48a, which will be referred to as side components, form a slight rearward obtuse angle with the center component. The center and side components in combination define three linear segments of the retractable shade which substantially conform with the curvature of the windshield 44 of the vehicle. The three linear segments in essence form chords along the curvature of the windshield as best seen in FIG. 3. In other words, while the three linear components do not have curved features but are rather individually straight, in combination they closely correspond or correlate with the curvature of the windshield. At the outermost ends of the side components 48b, shorter corner components 48c of the headrail form an obtuse angle with the side components but with the obtuse angle being much greater than the obtuse angle the side components make with the center component. Finally, end components 48d of the headrail form an obtuse extension from the corner components with the end components being substantially perpendicularly related to a vertical plane encompassing the center component 48a.

The curtain 54 of material in the retractable shade 40 is continuous from end to end and, as will be explained in more detail later, is uniquely formed at junctures between headrail components to prevent buckling or other distortion of the curtain material.

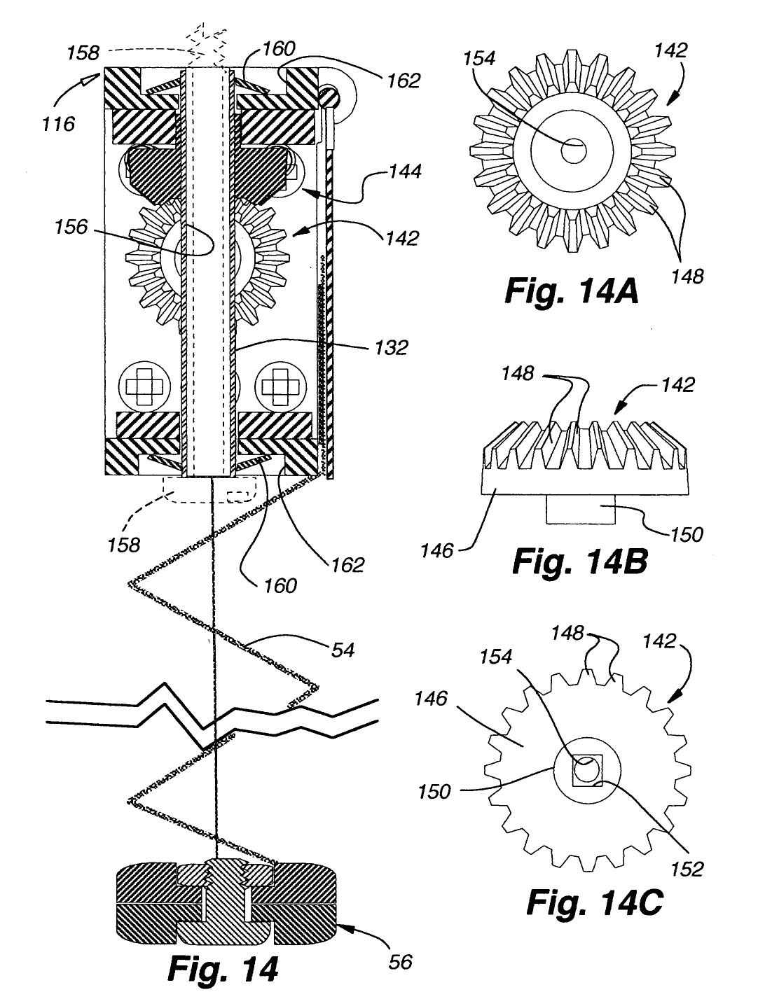

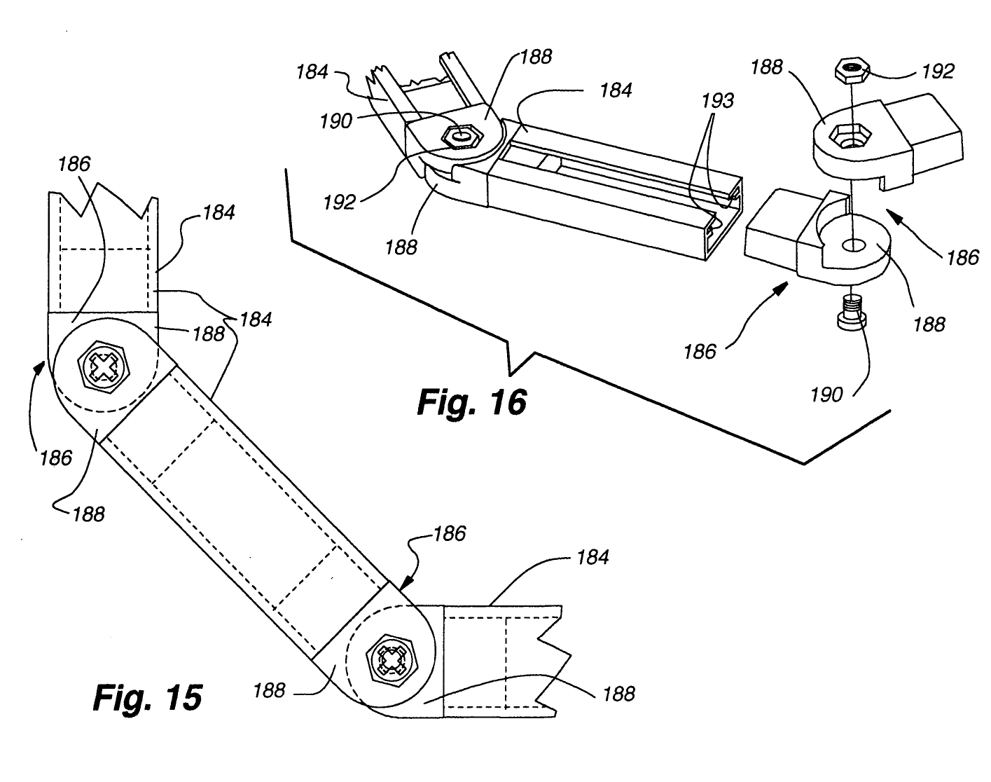

Each headrail component 48a, 48b, 48c and 48d is identical in cross-section with the only distinction being in the length of the component. The headrail components may be an extruded material such as aluminum, plastic, or the like, having a cross-section possibly best seen in FIGS. 9, 31, and 32. The headrail components in cross-section can be seen to include a front plate 78, a rear plate 80, four inwardly projecting channels 82 of generally C-shaped cross section forming pairs of such channels from the rear face of the front plate 78 and the front face of the rear plate 80. The lower channels of the front and rear plates are interconnected to form a connector wall 84 which extends perpendicularly to the front and rear plates. The lower edge of the rear plate 80 has an inwardly upturned lip 86 forming a channel 88 in which electrical wiring 90 or the like can be confined as seen in FIG. 9. The upper edge of the front plate 78 has an outwardly downturned channel 92 of C-shaped cross-section which can support a decorative valence 94 (FIGS. 4 and 14) or the like to cover the front plate of the headrail component in any desired decorative color or pattern. A confinement space 96 is defined between the connector wall 84 and the two upper inwardly directed channels 82. The confinement space receives various components of the retractable shade as will be described in more detail hereafter.

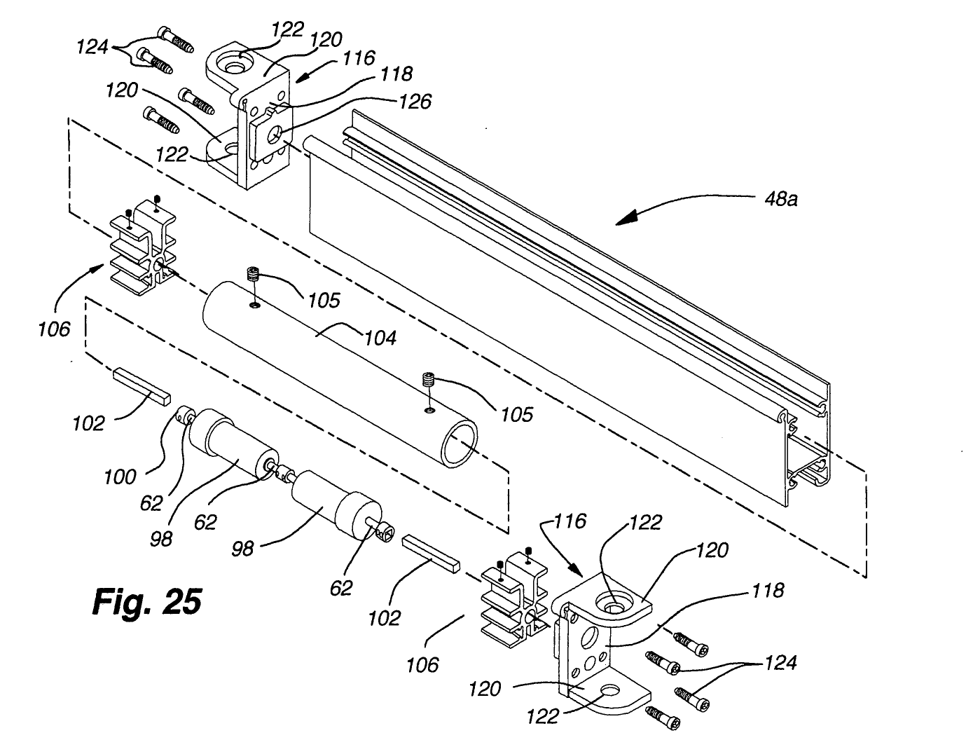

The center headrail component 48a is used to mount and house the motor drive unit 60 for the retractable shade as mentioned previously. The drive unit in the disclosed embodiment is a pair of back-to-back reversible electric motors 98 having their drive shafts 62 interconnected or coupled at adjacent ends of the motors so as to rotate in unison when energized. The opposite ends of the drive shafts protrude from the opposite ends of the motors and are used to drive a succession of the lift shafts 66 from the center headrail component to opposite ends of the retractable shade. The opposite ends of the motor drive shafts have square sockets 100 (FIG. 25) for receiving one end of a transfer shaft 102 having a square cross section so that the transfer shafts extend in opposite directions from the motors. The motors are seated within a tubular housing 104 having set screws 105 for anchoring the motors within the tubular housing. The tubular housing itself is positioned within the confinement space 96 of the center headrail component 48a and positively positioned therein by extruded positioning spiders 106 adjacent to opposite ends of the tubular housing.

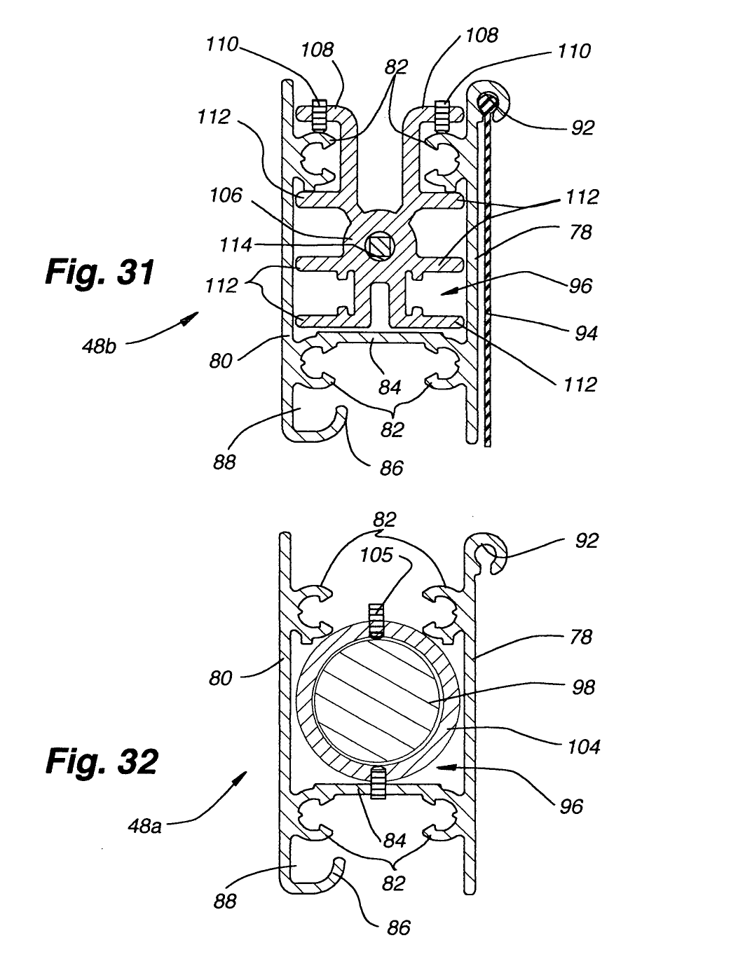

The positioning spiders 106 are identical in construction and can be selectively positioned within any of the housing components at any desired location as best seen in FIG. 31. The positioning spiders have upper out-turned arms 108 through which set screws 110 threadedly pass into engagement with the underlying, inwardly-directed upper channels 82 on the front 78 and rear 80 plates of the associated headrail component. Oppositely directed fingers 112 of each spider terminate in closely spaced relationship with the front and rear plates of the associated headrail component so that the spider is retained in a fixed position and in the case of the center headrail component, adjacent to the opposite ends of the tubular housing 104 and in abutting relationship therewith so that the tubular housing cannot move axially. Each spider 106 has an axial circular passage 114 that serves as a bearing for a lift shaft 66 passing therethrough as will be described later.

Referring to FIG. 25, each end of the center headrail component 48a has a bifurcated bracket 116 mounted therein. Each bifurcated bracket is identical with a vertical main body 118 and upper and lower horizontal plate-like arms 120. The plate-like arms have vertically aligned circular passages 122 therethrough. The bifurcated brackets are secured in the ends of the center headrail component 48a with four threaded fasteners 124 that pass through the main body of the bracket and are threadedly received in the open ends of the four inwardly directed channels 82 of the front 78 and rear 80 plates of the headrail component. It will be appreciated that the main body 118 of each bracket has a center horizontal passage 126 aligned with the axial passage 114 in the adjacent spider 106. Accordingly, when fully assembled, the center headrail component has the motor drive unit 60 positioned therein with oppositely directed transfer shafts 102 positioned adjacent opposite ends and rotatably supported by the brackets 116 and spiders 106 for rotation about their longitudinal axes.

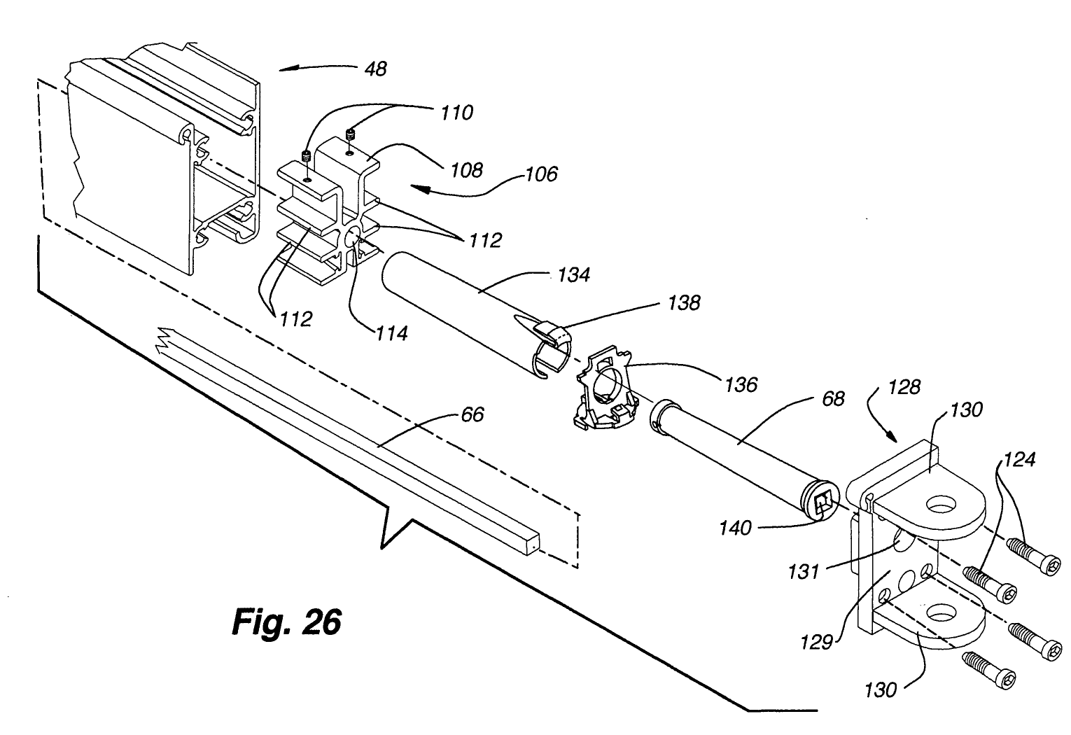

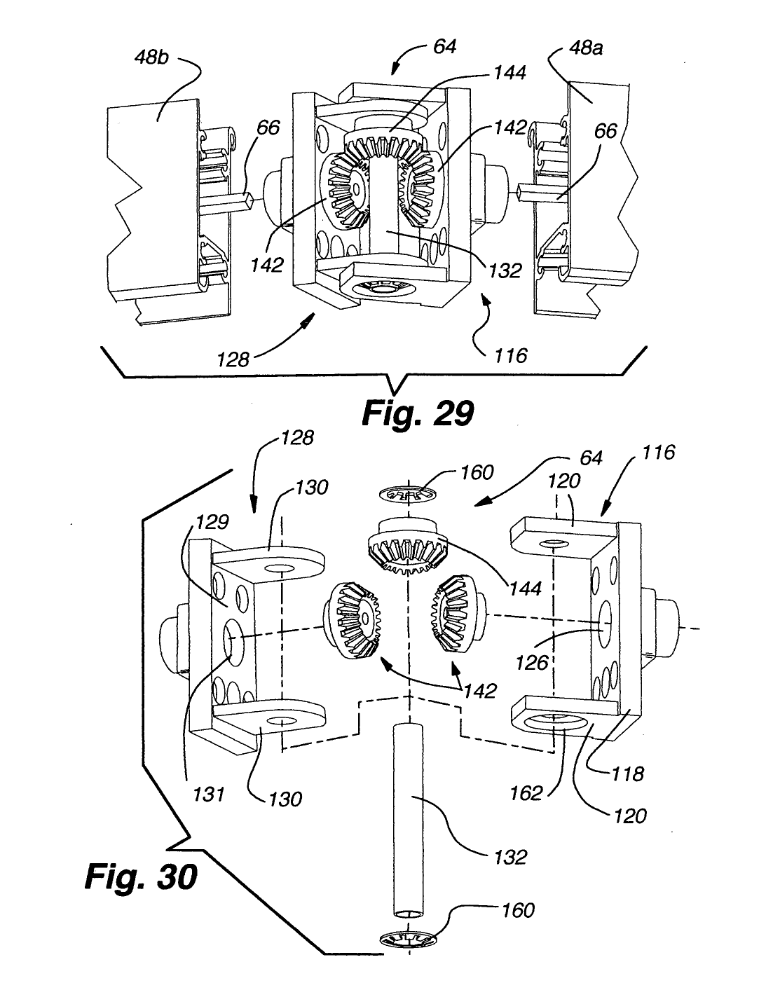

The side headrail components 48b adjacent to the center headrail component 48a are identical and as seen best in FIG. 26 each has a bifurcated bracket 128 at its end adjacent to the center headrail component that is similar to the bifurcated brackets 116 on the ends of the center headrail component but wherein upper and lower plate-like arms 130 thereof are spaced closer together than the corresponding arms of the bifurcated brackets 116 on the center headrail component. The brackets 128 have a main body 129 with a passage 131 therethrough to rotatably receive a lift shaft 66. The horizontal arms 120 and 130 of the bifurcated brackets 116 and 128, respectively, are adapted to be moved into over and underlying relationship, as seen best in FIG. 29, so that the circular vertical passages through the arms are aligned and adapted to receive a pivot cylinder 132 (FIG. 14) as will be described later. The opposite end of the side headrail components 48b have bifurcated brackets 116 mounted therein identical to the brackets on the center headrail component 48a and are adapted to be connected with a corner headrail component 48c that is identical, except for its length, to the side headrail components.

Each side headrail component 48b has a spool 68 rotatably mounted therein on a lift shaft 66 of square cross-section, with the spool itself being rotatably disposed within an outer cylindrical housing 134 (FIG. 26). The outer cylindrical housing is releasably connected to an end cap 136 with a spring catch 138 and the end cap is adapted to be abutted against an inner surface of the main body of an adjacent bifurcated bracket 116 or 128. A positioning spider 106 is positioned within the confinement space 96 of the side headrail component 48b and anchored so as to abut the other end of the outer cylindrical housing 134 for the spool 68 whereby the cylindrical housing for the spool and the spool itself are positively positioned adjacent to one end of the side headrail component. The spool receives and is mounted on a square lift shaft 66 which is designed to fit within a mating hole 140 in the spool to selectively rotate the spool in unison therewith. The opposite end of the lift shaft is rotatably supported within the positioning spider 106.

A transmitter 64 is positioned between the center headrail component 48a and each side headrail component 48b with the transmitter probably being best seen in FIGS. 29 and 30. Each transmitter includes a set of vertically disposed bevel gears 142 with each bevel gear being rotatably seated in a circular horizontal passage 126 or 131 through the main body of an associated one of the interconnected bifurcated brackets 116 or 128, respectively, at the juncture between the center and side headrail components. The bevel gears 142 are therefore rotatable about horizontal axes. A center, horizontally-disposed transfer bevel gear 144 is seated in the undersurface of an arm 130 of a bifurcated bracket 128 for rotation about a vertical axis. The three gears are intermeshed whereby rotative movement of one of the vertical bevel gears 142 is transmitted through the transfer bevel gear 144 to the other vertical bevel gear 142. It will be appreciated the vertical gears rotate in opposite directions but at a uniform rate. The vertically disposed bevel gears 142 are identical and shown in FIGS. 14A, 14B, and 14C. The vertically disposed bevel gears have a main body 146 with beveled gear teeth 148 and a gear shaft 150 off a rear face thereof. The gear shaft is adapted to be seated within the passage 126 or 131 in the main body of an associated bifurcated bracket 116 or 128, respectively. The gear shaft also has a square seat 152 formed in its end surface for mating receipt of a lift shaft 66 and a circular passage 154 resulting from the molding process.

The vertical bevel gears 142 are seated in the main bodies of associated bifurcated brackets 116 and 128 so that one bevel gear receives the transfer shaft 102 from one of the motors 98 in the motor unit and the other vertical bevel gear receives the lift shaft 66 from the adjacent side headrail component 48b. It will therefore be appreciated that through the intermeshing of the three bevel gears in the transmitter 64, rotative movement of the transfer shaft 102 in the center headrail component 48a is transferred to the lift shaft 66 of a side headrail component 48b.

The transfer gear 144 has a large axial passage 156 therethrough for receiving the pivot cylinder 132 that extends vertically through the horizontal plate-like arms 120 and 130 of the bifurcated brackets 116 and 128. The pivot cylinder also axially receives a mounting bolt 158 that extends into the open lower end and out the open upper end of the pivot cylinder so that the bolt can be anchored into the headliner 50 of the recreational vehicle to support the transmitter and thus the interconnected headrail components within the recreational vehicle. The pivot cylinder is fixed to the bifurcated brackets 116 with press nuts 160 that surround the pivot cylinder at opposite ends and are seated in recesses 162 in the outer surfaces of the horizontal arms 120 of the bifurcated brackets 116.

Identical transmitters 64 are positioned between each headrail component, and, as mentioned previously, the transmitters have complementary bifurcated brackets 116 and 128 that are pivotally interconnected so as to accommodate a variety of angles between adjacent headrail components. The selectable angular relationships accommodate the curvature or non-linear relationship of the window(s) in which the retractable shade 40 is mounted.

As mentioned previously, a corner headrail component 48c is positioned at the outer end of an associated side headrail component 48b and is interconnected therewith with a transmitter 64. The corner headrail component may or may not have a spool 68 associated therewith but has a lift shaft 66 extending therethrough to transfer rotative motion from the lift shaft in the side headrail component 48b to the lift shaft in the end headrail component 48d.

The end headrail components 48d, which are probably best illustrated in FIG. 27, have a spool 68 mounted therein as described previously in connection with the side headrail components 48b and as illustrated, the spool can be mounted in a reverse orientation if desired. Again, the spool is held in position within an end headrail component with a first positioning spider 106 as described previously. The outermost end of the square lift shaft 66 is received within the first spider and is also interconnected for unitary rotation with a coupler shaft 164 of hexagonal cross-section within the first spider. The coupler shaft 164 extends from the first positioning spider to a spaced but adjacent second positioning spider and is therewithin interconnected with a threaded shaft 166 for unitary rotation with the threaded shaft. Accordingly, rotation of the square lift shaft 66 entering the end headrail component 48d causes rotation of the coupler shaft 164 and the threaded shaft 166.

The threaded shaft 166 passes threadedly through a passage 168 in a movable spider 106M which is identical to the previously described spiders except it is not fixed in place within the end headrail component 48d and has the threaded passage 168 axially therethrough threadedly receiving the threaded shaft 166 so that it moves along the length of the threaded shaft upon rotation of the threaded shaft. The movable spider 106M is used as a stop for limiting movement of the curtain between the extended and retractable positions as will be described hereafter.

Movement of the movable spider 106M to the right as viewed in FIG. 27 will ultimately cause the movable spider to engage the adjacent fixed spider 106. Movement of the movable spider in the opposite direction or to the left as viewed in FIG. 27 will cause the movable spider to engage a vertical fixed post 170 which is seated in an opening 172 in the connector wall 84 of the headrail adjacent to the terminal end of the end headrail component 48d. The fixed post is held in place with a pair of press nuts 174 on opposite sides of the connector wall.

The manually operable switch 72 is anchored in the terminal end of one of the end headrail components 48d with fasteners 176. The electrical wiring 90 connects the switch 72 to the drive motors 98 with the wiring being confined within the channel 88 along the lower edge of the rear plate 80 of the headrail components as viewed in FIG. 9. The motors are reversibly drivable depending upon the position of the switch and accordingly by moving the switch to its uppermost position as seen in FIG. 27, the motors are caused to be driven in one direction thereby driving the threaded shaft 166 in one direction and moving the movable spider 106M in one direction along the length of the shaft. If the movable spider is moving to the right as viewed in FIG. 27, it ultimately engages the adjacent fixed spider 106 causing overload on the motor which shuts the motor down in a conventional manner. Movement of the switch to the opposite or lower position (not shown) causes the motors to be driven in the opposite direction thereby rotating the threaded shaft 166 in the opposite direction and causing the movable spider 106M to move to the left until it engages the fixed post 170 at which point it cannot move any further creating an overload on the motor and shutting the motor down in this position. The spacing between the fixed spider and the fixed post determines the extent of movement of the curtain from the fully retracted position to the fully extended position so that when the movable spider engages the adjacent fixed spider the shade is fully extended and when the movable spider engages the abutment post, the shade is fully retracted.

As a safety precaution, the movable spider 106M has a spring detent 178 mounted in its side having a push button 180 that becomes aligned with a hole 182 in the front side plate 78 of the end headrail component 48d when the shade is fully retracted. The push button is received in the hole 182 so that regardless of the position of the switch, the motors 98 will not be activated as the movable spider 106M is releasably locked in position causing an overload in the motors regardless of their direction of indicated operation. By depressing the button 180 on the spring detent simultaneously with moving the switch 72 to the upper position, the motors are allowed to operate inasmuch as the movable slide can then move along the threaded shaft 166 toward the adjacent fixed spider 106. This safety lock feature prevents the shade from being inadvertently operated to move it from a retracted to an extended position during operation of the recreational vehicle. In other words, both the spring detent and the switch need to be operated at the same time with two different hands before the shade can be extended.

The bottom rail 56 for the retractable shade is weighted and composed of extruded channel-shaped main body components 184 of preselected lengths corresponding to the length of an associated headrail component. Each component 184 of the bottom rail has an insert 186 in its opposite ends with the inserts being identical for each bottom rail component but reversed or inverted for adjacent bottom rail components. Each insert has a semi-circular plate 188 on its protruding end adapted to pivotally engage a corresponding semi-circular plate 188 of an adjacent bottom rail component. The inserts of adjacent bottom rail components are pivotally held together with a threaded pivot pin 190 having a hex nut 192 on its end to hold the joint between adjacent bottom rail components together in a pivotal relationship. The main body components have opposed channels 193 formed therein to receive an anchor strip 195 (FIG. 9) for anchoring the lower edge of the curtain 54 and the lift cords 70 in a conventional manner.

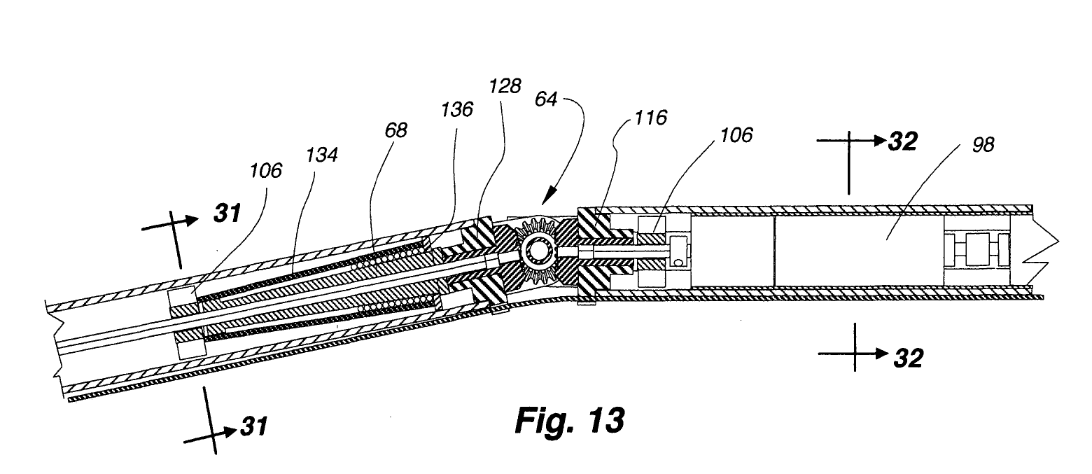

The vertically extending lift cords 70 have one end attached to an associated spool 68 and the opposite end to an anchor strip 195 in the bottom rail 56 in a conventional manner. Rotation of a spool by rotation of its associated lift shaft 66 causes the lift cord associated therewith to be wrapped around the spool (FIG. 13) within the surrounding cylindrical housing 134 for the spool. The cylindrical housing 134 is preferably spaced a short distance from the spool so as to prevent entanglement of the lift cord as it is being wrapped around a spool. Of course, as a lift cord is wrapped around its associated spool, its effective length is shortened thereby lifting the bottom rail of the shade. Since the lift shafts all rotate at the same speed of rotation, the bottom rail for the shade is raised uniformly along its entire length even though the lift cords are spaced along the length of the shade from one end to the other. As mentioned previously, while it is not imperative that a spool be mounted on every lift shaft, a sufficient number of spools are utilized to assure that the bottom rail is lifted at intervals that are small enough to permit an even lifting of the bottom rail.

It will be appreciated that the direction in which a spool 68 is rotated is not important and in fact due to the design of the transmitters 64, adjacent lift shafts 66 are in fact rotated in opposite directions. Accordingly, a spool on one lift shaft will wrap its associated lift cord in one direction while a spool on an adjacent lift shaft will wrap its associated lift cord in an opposite direction. The same is true when the lift shafts are rotated in the opposite direction but each spool is uniformly effective in lifting or lowering the bottom rail at a uniform speed.

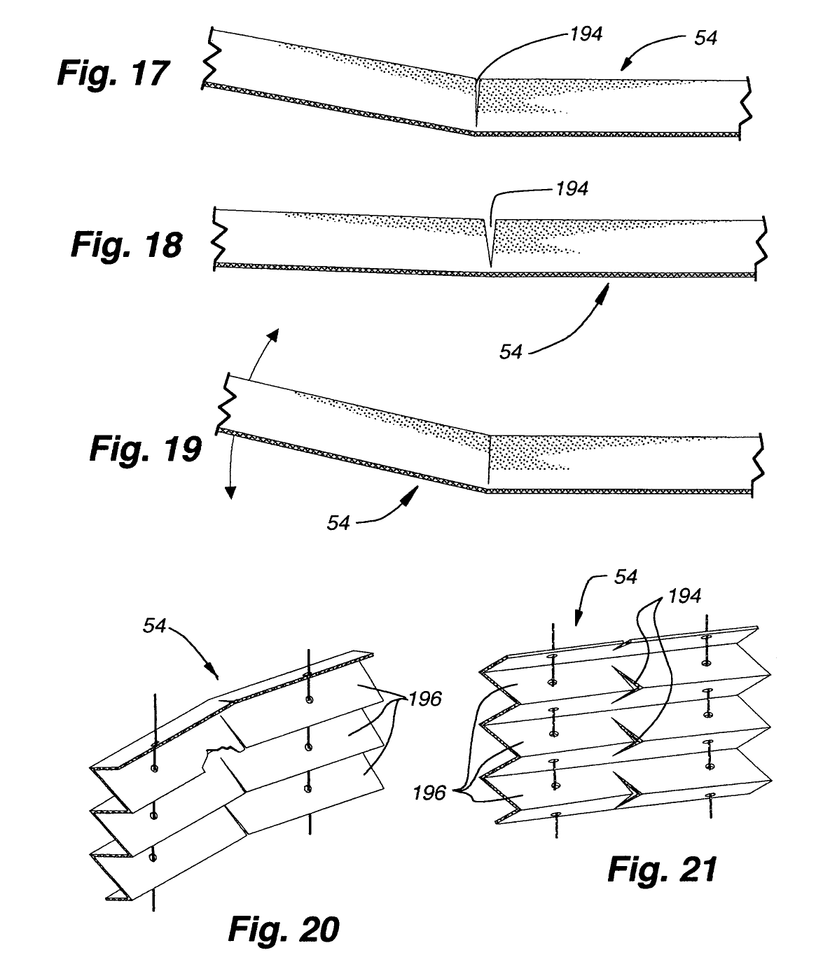

With reference to FIGS. 17-24, and as mentioned previously, the curtain 54 is formed so that at locations where it forms an angle to accommodate the curvature of an architectural opening or a location between adjacent non-linearly aligned openings, the curtain will not buckle or otherwise malform in an aesthetically distractive fashion. At a location where the curtain needs to turn or form an angle with an adjacent location in the curtain, i.e. at locations of the transmitters 64, the curtain is notched as shown in FIG. 18 with the notch 194 extending vertically through each of the pleats 196 in the curtain. This notching is possibly best illustrated in FIG. 21. The notch in the pleated curtain allows the curtain to be bent or folded in one direction as possibly best seen in FIGS. 17 and 19 with such a fold being partially made in FIG. 17 from the straight line orientation of FIG. 18 and fully folded in FIG. 19. It will also be appreciated that greater angles of fold can be accommodated with wider notching than that illustrated.

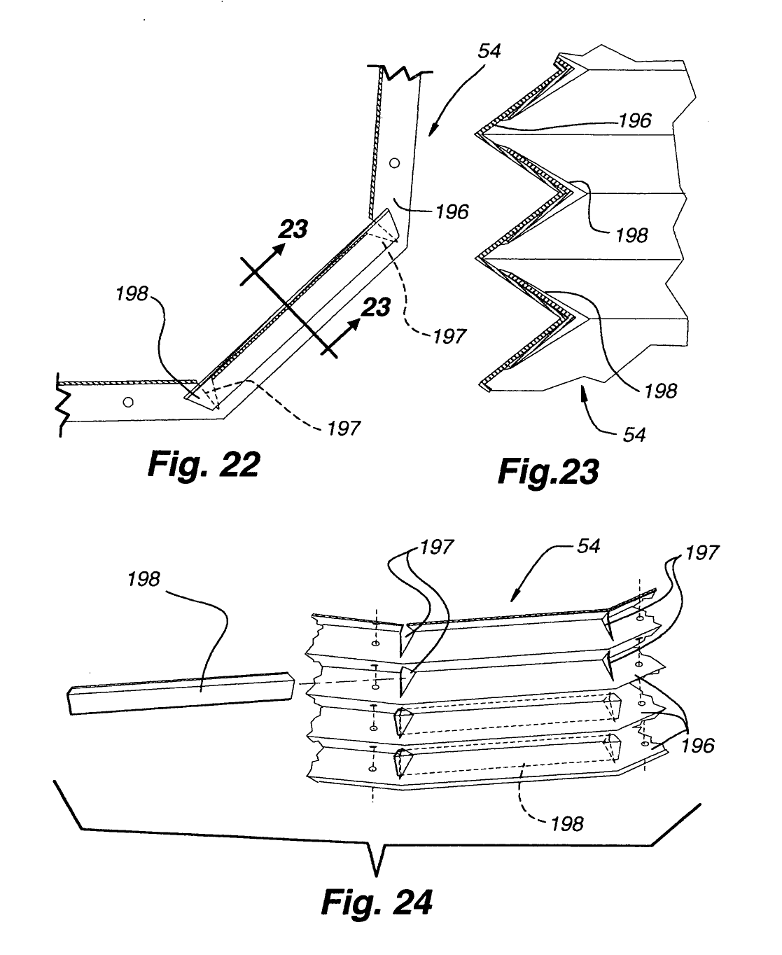

FIGS. 20 and 21 illustrate a fold in isometric views to illustrate how the shade 40 can conform to a fold or change in direction as is dictated by the relationship between adjacent components of the headrail 48. It will be appreciated if the notches 194 formed in the pleated curtain are relatively wide and the bend in the curtain is not very great, a gap or opening 197 (FIGS. 22 and 24) will be visible in the curtain at each location where a notch is formed. Such gaps permit the undesired passage of light and vision through the curtain. The gaps can be closed by passing folded insert strips 198 associated with each pleat 196 of the shade through a section of the shade extending between notches so that the insert strip protrudes a short distance beyond the notch as seen best in FIG. 22. In this manner, the insert strips block the passage of light or vision through the notches while not be distractive from an aesthetic standpoint particularly if made of the same material as the curtain material.

It will be appreciated from the above that a continuous retractable shade 40 capable of following a non-linear path in covering a non-linear window or adjacent windows which are in non-linear alignment has been described. The retractable shade has a continuous curtain 54 that passes through changes in direction without buckling and is vertically retracted or extended uniformly along its entire length. Further, the shade automatically stops when it has been fully retracted or fully extended and has a fail-safe system for preventing inadvertent extension of the shade. The shade is designed in modular components to accommodate various sized and shaped architectural openings or alignment of openings so that the shade can be used along straight linearly aligned openings or along curved or angularly related adjacent openings of various sizes.

Although the present invention has been described with a certain degree of particularity, it is understood the disclosure has been made by way of example and changes in detail or structure may be made without departing from the spirit of the invention as defined in the appended claims.

What is claimed is:

1. A retractable shade suitable for use in covering non-linearly aligned or curved openings comprising in combination:
at least one collapsible curtain adapted to be extended across at least one of said openings in an extended position and gathered adjacent to one side of at least one of said openings in a retracted position, and
a control system for moving said curtain between said extended and retracted positions, said control system including a plurality of elongated adjacent lift shafts capable of being disposed in non-linearly aligned relationship, said lift shafts being operatively connected to rotate about their longitudinal axis in unison in moving said curtain between said extended and retracted positions, and motor means operatively connected to said lift shafts for selectively rotating said lift shafts.

2. The retractable shade of claim 1 wherein said curtain has a plurality of segments with each segment being operatively associated with a lift shaft.

3. The retractable shade of claim 2 wherein said segments of said curtain are integrally connected.

4. The retractable shade of claim 2 wherein said lift shafts extend in substantially parallel relationship with an associated opening.

5. The retractable shade of claim 4 wherein adjacent ones of said lift shafts have adjacent ends and further including a transmitter between adjacent ends of said lift shafts for transmitting rotation of one lift shaft to the adjacent lift shaft so that each lift shaft rotates about its longitudinal axis at the same speed.

6. The retractable shade of claim 5 wherein said transmitter includes a set of gears.

7. The retractable shade of claim 6 wherein said gears are bevel gears.

8. The retractable shade of claim 1 wherein said control system further includes lift cords associated with said curtain for moving said curtain between said extended and retracted positions and spools around which said lift cords can be wrapped, said spools being operatively associated with said lift shafts for unitary rotation therewith.

9. The retractable shade of claim 8 further including a weighted bottom rail secured along a bottom edge of said curtain to which said lift cords are secured and wherein said lift shafts are disposed along an edge of said curtain opposite from said bottom rail.

10. The retractable shade of claim 9 wherein said bottom rail is continuous along said bottom edge of said curtain.

11. The retractable shade of claim 10 wherein said bottom rail includes a plurality of interconnected segments.

12. A retractable shade for a recreational vehicle, motor home, travel trailer, or the like, having single or multiple windows wrapping around a generally curved segment of the vehicle comprising in combination:
a collapsible curtain generally following said generally curved segment of the vehicle while being suspended along one edge of said curved segment and having a weighted bottom rail along an opposite edge, said curtain being movable between an extended position covering said generally curved segment and a retracted position adjacent to said one edge of said generally curved segment, and
a control system for moving said curtain between said extended and retracted positions, said control system including a plurality of adjacent, straight, non-linearly aligned lift shafts mounted for rotation about a longitudinal axis of the lift shaft, wherein adjacent ones of said lift shafts have adjacent ends, a transmitter positioned between said adjacent ends for transmitting rotation of one lift shaft to an adjacent lift shaft, said one edge of said curtain being adjacent to said lift shafts, a spool mounted on at least some of said lift shafts for unitary rotation therewith, and a lift cord secured at one end to said bottom rail and at an opposite end to an associated spool whereby rotation of a spool causes the associated lift cord to be wrapped or unwrapped from the spool moving said bottom rail toward or away respectively from said one edge of said curtain, and at least one motor for selectively rotating said lift shafts.

13. The retractable shade of claim 12 wherein said transmitter includes a set of gears.

14. The retractable shade of claim 13 wherein said gears are bevel gears.

15. The retractable shade of claim 12 wherein said curtain is one continuous curtain.

16. The retractable shade of claim 15 wherein said curtain includes notches at locations corresponding to at least some of said transmitters.

17. The retractable shade of claim 16 wherein said notches are formed in a line extending from said one edge of the curtain to said bottom rail.

18. The retractable shade of claim 17 wherein said curtain further includes inserts extending across said notches to block vision and light through said notches.

19. The retractable shade of claim 16 wherein said curtain is pleated.

20. The retractable shade of claim 12 wherein said one edge of the curtain is along an upper edge of said curved segment.
